(19) United States
(12) Patent Application Publication
(10) Pub. No.: US 2023/0334260 A1
(43) Pub. Date: Oct. 19, 2023

(54) INFORMATION PROCESSING DEVICE, PROGRAM, AND INFORMATION PROCESSING METHOD

(71) Applicant: bellFace Inc., Tokyo (JP)

(72) Inventors: Akihiro KOBAYASHI, Narashino-shi (JP); Masaru KAJI, Isehara-shi (JP)

(73) Assignee: bellFace Inc., Tokyo (JP)

(21) Appl. No.: 18/023,874

(22) PCT Filed: Aug. 25, 2021
(86) PCT No.: PCT/JP2021/031234

§ 371 Date: Feb. 28, 2023

(30) Foreign Application Priority Data
Sep. 17, 2020 (JP) 2020-156000

(51) Int. Cl. G06F 40/35

(52) U.S. Cl. CPC G06F 40/35

(57) ABSTRACT

A technique is provided for making it possible to easily grasp a replay time point of a specified keyword included in interview audio. Toward this end, an information processing device is configured so as to perform a character information generation step, an extraction step, and a visual information generation step. In the character information generation step, character information is generated that includes a transcript of the interview based on audio data of the interview. In the extraction step, the keyword is extracted from the character information. In the visual information generation step, visual information is generated in which the extracted keyword and the replay time point at which the keyword appears in the audio data are corresponded.

### TECHNICAL FIELD

The present invention relates to an information processing device, a program, and an information processing method.

### BACKGROUND ART

In recent years, there has been a demand for conducting interviews online. Further, in some cases where a content of the interview is desired to be verified, the content may be recorded and transcribed. PTL 1 discloses a teleconference support system that records the content of interviews.

### CITATION LIST

### Patent Literature

PTL 1: Japanese Patent Laid-Open No. 2013-26706

### SUMMARY OF INVENTION

### Technical Problem

Incidentally, when replaying interview audio, a user may wish to verify a replay time point at which participants have had a conversation with a specific keyword. However, if the user has not remember what has been discussed during the interview, it is difficult for the user to immediately grasp the replay time point when the specific keyword has been used.

The present invention has been made in view of the above circumstances and provides a technology for easily grasping the replay time point of a specific keyword included in interview audio.

### Solution to Problem

According to a mode of the present invention, an information processing device is provided. The information processing device is configured to perform a character information generation step, an extraction step, and a visual information generation step. The character information generation step generates character information including a talk script of an interview from audio data of the interview. The extraction step extracts a keyword from the character information. The visual information generation step generates visual information in which the extracted keyword is associated with a replay time point at which the keyword appears in the audio data.

The above configuration allows the user easy to grasp the replay time points of a specific keyword included in interview audio.

### BRIEF DESCRIPTION OF DRAWINGS

FIG. 1 is a schematic diagram depicting a configuration overview of a system 1 according to the present embodiment.

FIG. 2 is a block diagram depicting a hardware configuration of an information processing device 3.

FIG. 3 is a functional block diagram depicting functions of the information processing device 3.

FIG. 4 is an activity diagram depicting an example of information processing performed by the information processing device 3.

FIG. 5 is a schematic diagram depicting an example of Graphical User Interface (GUI) displayed on a display part of an audio replay terminal 2.

FIG. 6 is an activity diagram depicting another example of the information processing performed by the information processing device 3.

### DESCRIPTION OF EMBODIMENT

An embodiment of the present invention is described below with reference to the accompanying drawings. Various characteristic matters described in conjunction with the embodiment below may be variably combined with one another.

Incidentally, a program for implementing the software working in conjunction with the embodiment may be offered in the form of a computer-readable, non-temporary recording medium, in a manner downloadable from an external server, or by use of an external computer activating the program to let client terminals implement the functions represented by the program (so-called cloud computing).

Further, in this embodiment, the expression “part” may include a combination of hardware resources implemented by circuits in a broad sense with software-based information processing that may be executed specifically by such hardware resources. Furthermore, the embodiment handles various kinds of information represented by physical values of signal values indicative of voltages and currents, by highs and lows of signal values representing aggregates of binary bits of 0 s and 1s, or by quantum superpositions (so-called quantum bits). Communications and computations may be performed by the circuits in a broad sense.

Further, the circuits in the broad sense are implemented by at least appropriately combining circuits, circuitry, processors, memories, and the like. That is, the circuits include an Application Specific Integrated Circuit (ASIC) and programmable logic devices (e.g., Simple Programmable Logic Device (SPLD), Complex Programmable Logic Device (CPLD), and a Field Programmable Gate Array (FPGA)).

1. Hardware Configuration

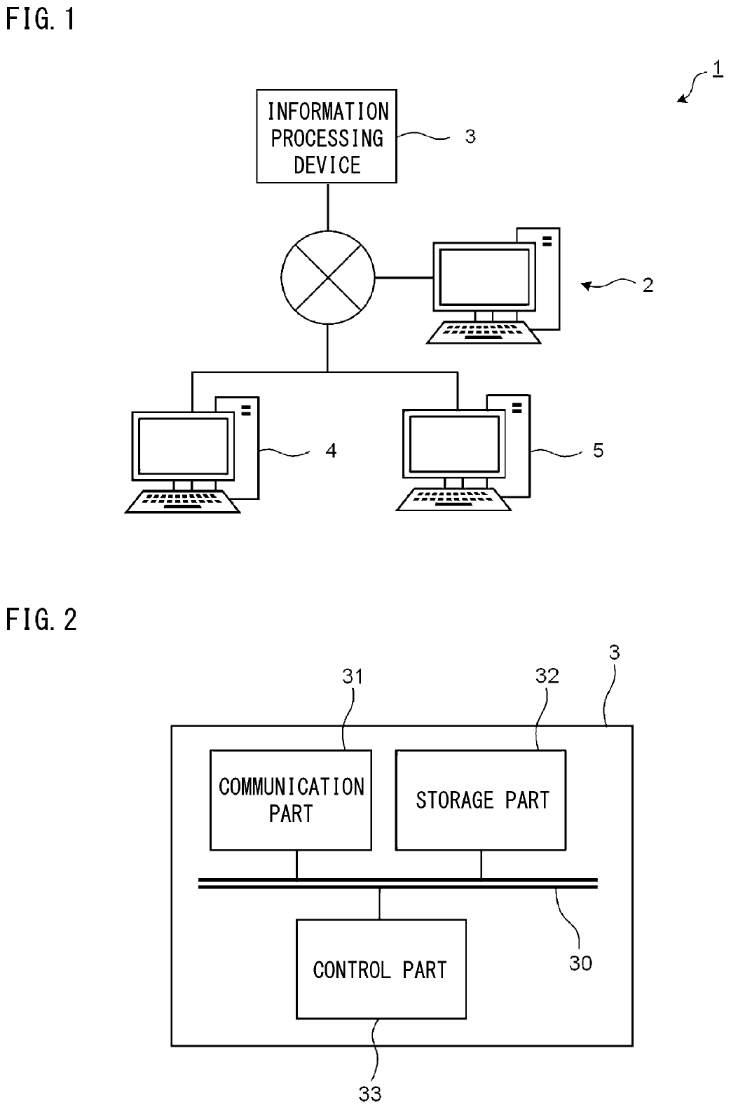

This chapter explains a hardware configuration of this embodiment. FIG. 1 is a schematic diagram depicting a configuration overview of a system 1 in the embodiment.

1.1 System 1

The system 1 includes an audio replay terminal 2, an information processing device 3, a first user terminal 4, and a second user terminal 5. These constituent elements are configured in a manner communicable with each other via telecommunication lines.

1.2 Audio Replay Terminal 2

The audio replay terminal 2 is operated by a person replaying the audio data of interviews. This terminal may be implemented as a smartphone, a tablet terminal, a computer, or in any other form of apparatus as long as it can access the information processing device 3 via a telecommunication line.

The audio replay terminal 2 includes a display part, an input part, a communication part, a storage part, and a control part. These constituent elements are electrically connected with each other via a communication bus inside the audio replay terminal 2.

The display part and the input part may be included in a housing of the audio replay terminal 2 or may be attached externally thereto. The display part displays screens of a GUI with operatable by a user. The input part may be integrated with the display part to constitute a touch panel. The user may perform a tap, a swipe, or other operations for input on the touch panel. Obviously, the touch panel may be replaced by switch buttons, a mouse, a QWERTY keyboard, or the like.

The reader is referred to the subsequent descriptions of a communication part 31, a storage part 32, and a control part 33 in the information processing device 3 for specific explanations of the communication part, the storage part, and the control part.

1.3 Information Processing Device 3

FIG. 2 is a block diagram depicting a hardware configuration of the information processing device 3. The information processing device 3 includes the communication part 31, the storage part 32, and the control part 33. These constituent elements are electrically connected with each other via a communication bus 30 inside the information processing device 3. Each of the constituent elements is explained below in more detail.

(Communication Part 31)

The communication part 31 may preferably be formed by wired communication means such as a Universal Serial Bus (USB), Institute of Electrical and Electronics Engineers (IEEE) 1394, Thunderbolt, or wired Local Area Network (LAN) network communication. Wireless LAN network communication, mobile communication such as Long Term Evolution (LTE)/3G, or Bluetooth (registered trademark) communication may also be included as needed. More preferably, the communication part 31 may be implemented as an aggregate of such multiple communication means.

(Storage Part 32)

The storage part 32 stores various kinds of information defined in the foregoing paragraphs. For example, the storage part 32 may be implemented as a storage device such as a Solid-State Drive (SSD) for storing various programs performed by the control part 33 for the information processing device 3, as a memory such as a Random-Access Memory (RAM) for storing temporarily needed information (arguments, arrays, etc.) for program execution, or as a combination of these constituent elements.

In particular, the storage part 32 stores interview audio data, character information 6, a keyword 60 extracted by an extraction part 335, and the like. The interview audio data refers to the audio data of interviews conducted by multiple persons (e.g., by a first user 4a and a second user 5a). Here, the interviews include, for example, a business negotiation, a meeting, a job interview, a conference, a seminar, a class, or the like conducted over a network. In addition to these activities, any session where multiple users communicate with each other by video and audio over the network is included in the category of interviews. The interview is not limited to a one-to-one exchange; the interview may also be a one-to-many exchange, a many-to-one exchange, or a many-to-many exchange. Note that the audio data may be included in video data and may be stored in the form of video data in the storage part 32. Although the audio data is explained as related to the business negotiation between the first user 4a, who is a sales representative, and the second user 5a, who is a customer, as an example for this embodiment, the audio data is not limited to the business negotiation. The audio data applies to any scene involving talks in addition to the business negotiation.

(Control Part 33)

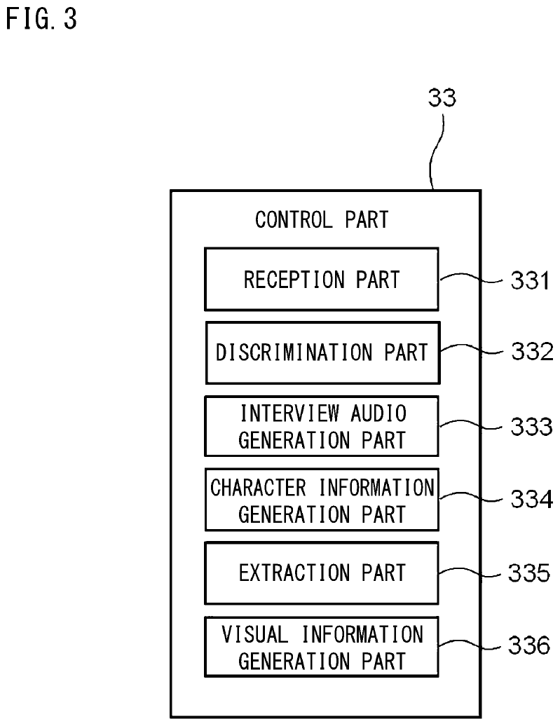

The control part 33 processes and controls overall activities related to the information processing device 3. For example, the control part 33 may be a central processing unit (CPU), not depicted. By reading relevant programs from the storage part 32, the control part 33 implements various functions of the information processing device 3. That is, the functions may be realized as various functional parts included in the control part 33 (see FIG. 3) by means of hardware (control part 33) that specifically implements information processing based on software (stored in the storage part 32). The functional parts will be discussed in more detail in the ensuing paragraphs. It is to be noted that the control part 33 is not limited to being a single entity. Alternatively, multiple control parts 33 may be provided for each function. As another alternative, combinations of a single control part 33 and multiple control parts 33 may be provided for each function.

1.4 First User Terminal 4

The first user terminal 4 is operated by the first user 4a. The first user terminal 4 may be a smartphone, a tablet terminal, a computer, or any other form of apparatus as long as it can access the information processing device 3 via a telecommunication line. The first user 4a is a participant in the interview, such as a sales representative selling products or services, a job seeker having a job interview, or an instructor or lecturer holding a seminar or a class. Note that there may be multiple first user terminals 4 and multiple first users 4a operating the first user terminal or terminals 4.

The first user terminal 4 includes a display part, an input part, a communication part, a storage part, and a control part. These constituent elements are electrically connected with each other via a communication bus inside the first user terminal 4 located externally. The reader is referred to the description of the audio replay terminal 2 and the information processing device 3 for the explanation of each of the constituent elements.

1.5 Second User Terminal 5

The second user terminal 5 is operated by the second user 5a. This terminal may be a smartphone, a tablet terminal, a computer, or any other form of apparatus as long as it can access the information processing device 3 via a telecommunication line. The second user 5a is another participant in the interview, such as a customer of the first user 4a, an interviewer at a job interview, or an enrollee or a student in a seminar or a lecture. Note that there may be multiple second user terminals 5 and multiple second users 5a operating the second user terminal or terminals 5.

The second user terminal 5 includes a display part, an input part, a communication part, a storage part, and a control part. These constituent elements are electrically connected with each other via a communication bus inside the second user terminal 5. The reader is referred to the description of the audio replay terminal 2 and the information processing device 3 for the explanation of each of the constituent elements.

2. Functional Configuration

This chapter explains a functional configuration of this embodiment. FIG. 3 is a functional block diagram depicting the functions of the information processing device 3. As described above, the functions are realized as various functional parts included in the control part 33 by means of the hardware (control part 33) specifically implementing the information processing based on the software (stored in the storage part 32).

Specifically, the information processing device 3 (control part 33) includes a reception part 331, a discrimination part 332, an interview audio generation part 333, a character information generation part 334, an extraction part 335, and a visual information generation part 336 as the functional parts.

(Reception Part 331)

The reception part 331 performs a reception step. The reception part 331 receives information via either the communication part 31 or the storage part 32 and has the received information configured in a readable manner in working memory. In particular, the reception part 331 is configured to receive various kinds of information (e.g., audio data or video data including the audio data) from the first user terminal 4 and from the second user terminal 5 over a network and the communication part 31. It is explained below, as an example for this embodiment, that the various kinds of information received by the reception part 331 is stored into the storage part 32 and configured in a readable manner in working memory.

(Discrimination Part 332)

The discrimination part 332 performs a discrimination step. The discrimination part 332 carries out a speech recognition process on the audio data to discriminate a speech by the first user 4a and a speech by the second user 5a in the audio data. The speech by the first user 4a and the speech by the second user 5a are separately stored in the storage part 32 and configured in a readable manner in working memory. The algorithm for speech recognition is not limited to anything specific. For example, an algorithm that uses natural language processing based on machine learning or other algorithms may suitably be adopted.

(Interview Audio Generation Part 333)

The interview audio generation part 333 performs an interview audio generation step. The interview audio generation part 333 generates audio data that discriminably includes first audio data and second audio data. The audio data generated by the interview audio generation part 333 is stored into the storage part 32 and configured in a readable manner in working memory.

(Character Information Generation Part 334)

The character information generation part 334 performs a character information generation step. The character information generation part 334 generates character information 6 from the audio data stored in the storage part 32 and controls the display part of the audio replay terminal 2, for example, to display the character information 6. Alternatively, the character information generation part 334 may generate only rendering information for causing the character information 6 to be displayed on the display part of the audio replay terminal 2, for example. The character information 6 generated by the character information generation part 334 is stored into the storage part 32 in association with the audio data and configured in a readable manner in working memory.

(Extraction Part 335)

The extraction part 335 performs an extraction step. The extraction part 335 extracts a keyword 60 from the character information 6. Note that, the keyword 60 to be extracted by the extraction part 335 may be set beforehand. Such settings are stored in the storage part 32.

(Visual Information Generation Part 336)

The visual information generation part 336 performs a visual information 7 generation step. The visual information generation part 336 generates visual information 7 including various kinds of information to be stored in the storage part 32 (e.g., icons 70), or screens, images, or the like that include such information, and controls the display part of the audio replay terminal 2, for example, to display the visual information 7. Alternatively, the visual information generation part 336 may generate only rendering information for causing the visual information 7 to be displayed on the display part of the audio replay terminal 2, for example. The visual information 7 generated by the visual information generation part 336 is stored into the storage part 32 and configured in a readable manner in working memory.

3. Details of Information Processing

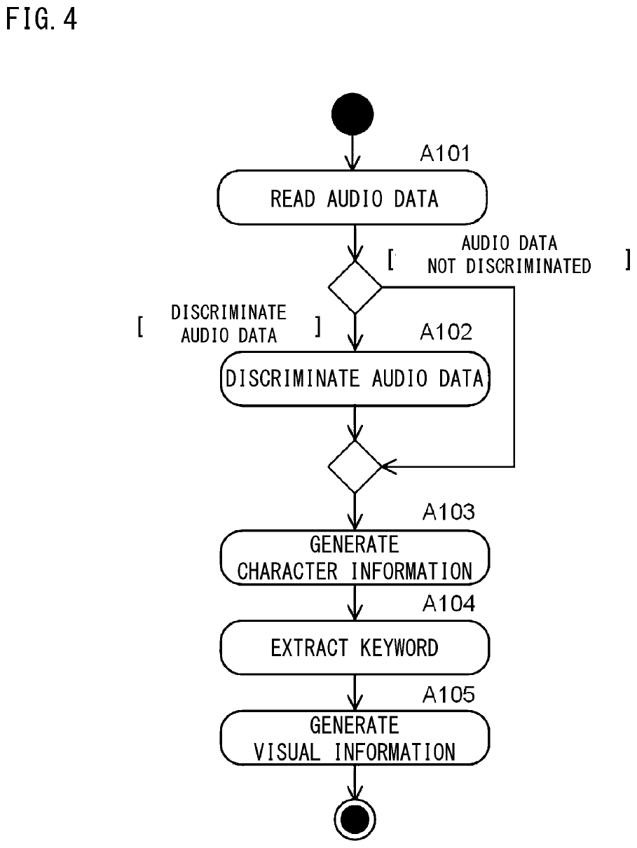

This chapter explains the information processing performed by the above-described information processing device 3 with reference to the accompanying activity diagrams. FIG. 4 is an activity diagram depicting an example of the information processing carried out by the information processing device 3.

3.1 Case Where Audio Data Is Stored Beforehand in Information Processing Device 3

The paragraphs that follow explain the case where audio data is stored beforehand in the information processing device 3.

First, the reception part 331 reads the audio data from the storage part 32 of the information processing device 3 into working memory (A101). In the case where the first audio data about the first user 4a and the second audio data about the second user 5a are to be discriminated, A102 is reached. In a case where such discrimination is not performed, A103 is reached.

In A102, the discrimination part 332 performs a speech recognition process on the audio data, discriminating a speech by the first user 4a and a speech by the second user 5a in the audio data. Here, the discrimination part 332 recognizes the speaker in the interview (e.g., the first user 4a as a sales representative or the second user 5a as a customer) on the basis of audio data waveforms. Further, the discrimination part 332 may have physical quantities such as the voice frequencies of the first user 4a and/or of the second user 5a stored beforehand and, by comparing the audio data with the stored data, identify the first user 4a and/or the second user 5a so as to recognize the speaker. As another example, the discrimination part 332 may input the audio data to a trained model having learned the content likely to be spoken by the first user 4a and/or by the second user 5a during interviews and, on the basis of what the model outputs regarding whether the input audio data belongs to the first user 4a or to the second user 5a, recognize the speaker. The speeches thus recognized are stored separately into the storage part 32.

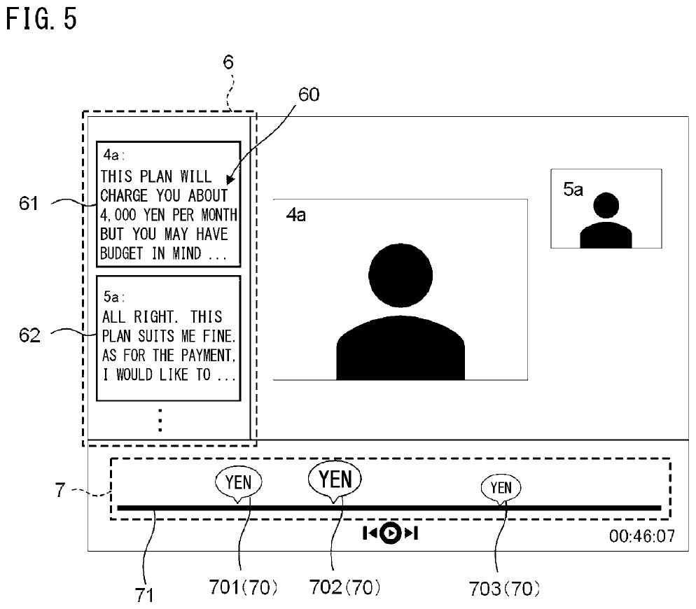

The character information generation part 334 proceeds to generate the character information 6 including talk scripts of the interview out of the interview audio data (A103). FIG. 5 is a schematic diagram depicting an example of a GUI displayed on the display part of the audio replay terminal 2. As depicted in FIG. 5, from the audio data of the interview conducted by the first user 4a and the second user 5a, the character information generation part 334 generates the character information 6 including talk scripts that indicate the content spoken by the respective users.

In the case where first character information 61 and second character information 62 are generated by discriminating either the audio data or the speeches included therein, the first character information 61 and the second character information 62 are displayed in a discriminatable manner on the display part of the audio replay terminal 2. Specifically, in the case where the read-out audio data has a data structure allowing the first audio data and the second audio data to be discriminated from each other, the character information generation part 334 generates the first character information 61 including the talk script of the first user 4a from the audio data of the speech by the first user 4a. Also, the character information generation part 334 generates the second character information 62 including the talk script of the second user 5a from the audio data of the speech by the second user 5a.

Further, in the case where the audio data is discriminated by the discrimination part 332 into the speech by the first user 4a and the speech by the second user 5a, the character information generation part 334 generates the first character information 61 including the talk script of the first user 4a from the speech by the first user 4a, and the second character information 62 including the talk script of the second user 5a from the speech by the second user 5a.

Next, the extraction part 335 extracts a keyword 60 from the character information 6 (A104). Here, the keyword 60 may include, for example, date and time information, customer information (customer's name, company name, division name, age, gender, etc.), and product or service related information, or the like (product name, product price, number of products, etc.). Further, for example, the keyword 60 may be a unit and preferably a currency but is not limited thereto. There may be multiple keywords 60 to be extracted by the extraction part 335. In the example of FIG. 5, the Japanese currency “yen” included in the talk script of the first user 4a is extracted as the keyword 60. Note that, the word “4000 yen,” which includes the price, may be extracted as the keyword 60. Further, predetermined settings may be used to extract prices equal to or larger than a given amount. There may be multiple kinds of keywords 60 to be extracted. The extracted keywords 60 are stored into the storage part 32.

In particular, in the case where the audio data is discriminated, the extraction part 335 should preferably be arranged to extract the keyword 60 only from the first character information 61. This arrangement permits extraction of the keyword 60 included only in the audio data about the first user 4a. When the visual information 7, to be discussed below, is displayed, the person replaying the interview audio can grasp only the keyword 60 spoken by the sales representative and the replay time points at which the keyword 60 appears.

Next, in A105, the visual information generation part 336 generates the visual information 7 in which the extracted keyword 60 is associated with the replay time points at which the keyword 60 appears in the audio data. Specifically, the visual information generation part 336 generates the visual information 7 in which the extracted keyword 60 is associated with a seek bar 71 indicating a replay position of the audio data. In this case, if the keyword 60 included only in the first character information 61 is extracted, the visual information 7 regarding the specific keyword 60 included only in the speech by the first user 4a is generated. When the visual information 7 is thus generated in which the keyword 60 is associated with the replay points at which the keyword 60 appears in the seek bar 71, the person replaying the audio data can immediately grasp the replay points of the specific keyword 60 in the interview audio.

Here, the visual information 7 may, for example, be an icon 70 recognizable as being associated with the keyword 60. For example, the visual information generation part 336 generates the icon 70, which includes the keyword 60 associated with replay time points, in those positions in the seek bar 71 which permit recognition of the replay time points at which the keyword 60 appears. As depicted in FIG. 5, the visual information generation part 336 generates the visual information 7 in such a manner that the extracted keyword 60 is included in the icon 70. Here, the position in which the icon 70 can be recognized should preferably be above, below, on the left of, or on the right of each replay time point at which the keyword 60 appears in the seek bar 71, for example. These four positions also include the top right, top left, bottom right, and bottom left of each replay time point. When positioned in this manner, the juxtaposed display allows the person replaying the audio data to intuitively grasp the replay time points at which the keyword 60 appears. In the example of FIG. 5, the icon 70 includes “yen,” which is the keyword 60 extracted from the first character information 61. Alternatively, the icon 70 may not include the keyword 60.

Also, the visual information generation part 336 should preferably generate the visual information 7 in such a manner that multiple keywords 60 appear in a recognizable order. When multiple keywords 60 are extracted as depicted in FIG. 5, the visual information generation part 336 should preferably be arranged to generate icons 701, 702, and 703 in such manner that they are displayed side by side in chronological order of the replay time points at which the keyword 60 appears in the audio data. This arrangement allows the person replaying the interview audio and verifying a specific keyword 60 therein to intuitively grasp how many specific keywords 60 appear and at which time points they appear in the interview audio.

3.2 Case where Audio Data is Received from First User Terminal 4 and from Second User Terminal 5

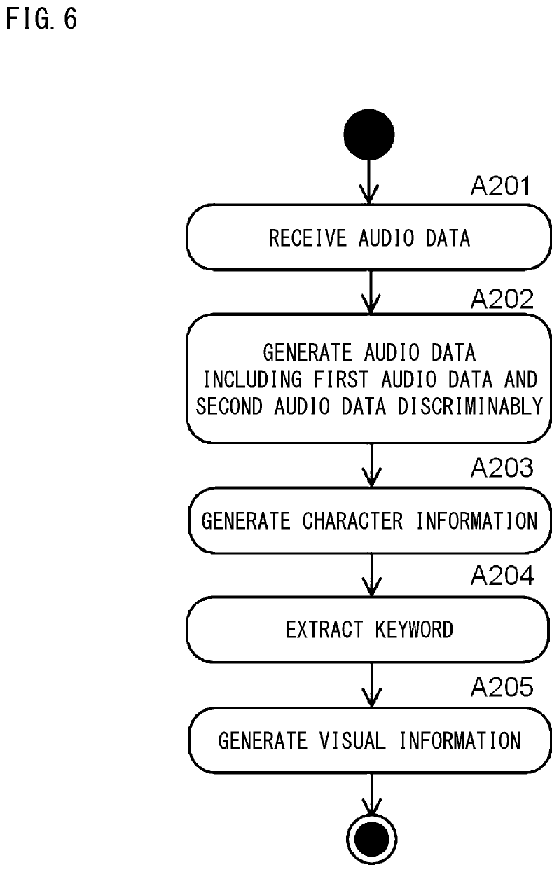

The paragraphs that follow explain the information processing in the case where the audio data is received from the first user terminal 4 and from the second user terminal 5. FIG. 6 is an activity diagram depicting another example of the information processing performed by the information processing device 3.

The reception part 331 receives the first audio data from the first user 4a and the second audio data from the second user 5a (A201). Specifically, the reception part 331 distinguishably receives the first audio data transmitted from the first user terminal 4 and the second audio data from the second user terminal 5 via the communication part 31. The first and the second audio data thus received are stored into the storage part 32. Since the transmission sources are already known, the first and the second audio data may be received in a manner distinguishable from each other.

In A202, the interview audio generation part 333 proceeds to generate audio data that includes the first audio data and the second audio data in a manner discriminatable from each other. Specifically, for example, the audio data may be generated in such a manner that the header information thereof and the like include a description associating the replay time with the first or the second audio data being in effect.

In A203, the character information generation part 334 generates the first character information 61 including the talk script of the first user 4a from the first audio data and the second character information 62 including the talk script of the second user 5a from the second audio data.

The extraction part 335 then extracts the keyword 60 from the first character information 61 (A204).

Thereafter, the visual information generation part 336 generates the visual information 7 in which the extracted keyword 60 is associated with the replay time points at which the keyword 60 appears in the audio data (A205). Note that, the reader is referred to the description in 3.1 for the explanation of the visual information 7.

The above-described information processing thus permits generation of the visual information 7 from the audio data even in a format allowing the speech by the first user 4a and the speech by the second user 5a to be discriminated from each other, as in the case where the audio data is stored beforehand in the information processing device 3.

As described above, this embodiment makes it possible to display at which replay time points the specific keyword 60 is used in the audio of the interview conducted by the sales representative and the customer. This allows the person replaying the interview audio to grasp specific timings at which a good sales representative uses a specific keyword 60 to improve sales performance. The findings from the interview audio can be used to train other sales representatives.

4. Others

With regard to the system 1 according to the present embodiment, the present invention may be provided in the following modes.

(1-1) The visual information generation part 336 may generate the visual information 7 in such a manner that the information is displayed in a different manner depending on the extracted keyword 60. For example, if the extracted keyword 60 represents a currency, the visual information 7 may be generated in a different color or in a different size depending on the amount of money indicated by the keyword 60. As another example, the visual information 7 may be displayed in a different manner depending on whether the extracted keyword 60 indicates customer information or a product price.

(1-2) In the case where the extracted keyword 60 indicates the currency, an icon 70 representing the keyword 60 indicative of a large amount of money may be generated in a manner different from the other icons 70. For example, the visual information generation part 336 may perform control in such a manner that the icon 70 representing the extracted keyword 60 indicative of the largest amount of money is displayed in the largest size and in a color different from that of any other icon 70. As another example, the larger the amount of money indicated by the keyword 60 is, the more conspicuously the icon 70 is generated by the visual information generation part 336. Specifically, if the extracted keywords 60 include 1,000 yen and 10,000 yen, the visual information 7 related to 10,000 yen is generated in a larger size than the visual information 7 related to the smaller amount. For example, in the case where the icon 702 represents the visual information 7 indicative of 10,000 yen and the icon 703 denotes the visual information 7 indicative of 1,000 yen, then the icon 702 is displayed larger than the icon 703, as depicted in FIG. 5.

(1-3) In the case where the icons 70 include the extracted keyword 60, the visual information generation part 336 performs control in such a manner that the keyword 60 indicating a large amount of money is displayed in larger or bolder characters than the remaining keywords 60 included in the icons 70. In the example of FIG. 5, the icon 702 is displayed in a bolder character than the icon 703.

(1-4) In the case where the keyword 60 is extracted from both the first character information 61 and the second character information 62, the visual information generation part 336 may generate the visual information 7 in such a manner than the information is displayed in a different manner depending on whether the keyword 60 is extracted from the first character information 61 or from the second character information 62. For example, control may be performed so that the visual information 7 related to the keyword 60 extracted from the first character information 61 is displayed in blue and the visual information 7 related to the keyword 60 extracted from the second character information 62 is displayed in red.

(2) In the case where the first character information 61 and the second character information 62 are discriminated from each other, the keyword 60 may be extracted only from the second character information 62. This allows a person replaying the interview audio to grasp only the keyword 60 included in the speech by the second user 5a and the replay time points of the audio data associated with the keyword 60, and allows the person replaying the interview audio to grasp specific timings at which the customer uses a specific keyword 60. The findings from the interview audio can be used to train other sales representatives.

(3) The information processing device 3 may also be implemented by use of a dedicated program installed in a computer.

(4) Another mode of the present embodiment may be a program. The program causes a computer to perform the steps of the information processing device 3.

(5) Another mode of the present embodiment may be an information processing method. The information processing method includes a character information generation step, an extraction step, and a visual information generation step. The character information generation step generates character information 6 including a talk script of an interview from audio data of the interview. The extraction step extracts a keyword 60 from the character information 6. The visual information generation step generates visual information 7 in which the extracted keyword 60 is associated with a replay time point at which the keyword 60 appears in the audio data.

The present invention may preferably be provided in the following modes. The information processing device, in which there are multiple keywords, and in which the visual information generation step generates the visual information in which the multiple keywords can be discriminated in order of appearance thereof.

The information processing device, in which the visual information generation step generates the visual information in which the extracted keyword is associated with a seek bar indicative of a replay position of the audio data.

The information processing device, in which the visual information generation step generates an icon including the keyword associated with the replay time point, in a position permitting recognition of the replay time point at which the keyword appears in the seek bar.

The information processing device, in which the position in which the icon is recognizable is at least above, below, on the left of, or on the right of the replay time point at which the keyword appears in the seek bar.

The information processing device, in which the interview is conducted by a first user and a second user, in which the character information generation step generates first character information including the talk script of the first user and second character information including the talk script of the second user from the audio data, and in which the extraction step extracts the keyword from the first character information.

The information processing device further configured to perform a discrimination step, in which the discrimination step performs a speech recognition process on the audio data to discriminate a speech by the first user and a speech by the second user in the audio data, and in which the character information generation step generates the first character information from the speech by the first user and the second character information from the speech by the second user.

The information processing device further configured to perform a reception step and an interview audio generation step, in which the reception step receives first audio data from the first user and second audio data from the second user, and in which the interview audio generation step generates the audio data including discriminably the first audio data and the second audio data.

The information processing device, in which the first user is a sales representative and the second user is a customer, and in which the audio data includes a business negotiation between the sales representative and the customer.

The information processing device, in which the keyword is a unit.

The information processing device, in which the keyword is a currency.

A program for causing a computer to perform the steps of the information processing device.

An information processing method for an information processing device, including a character information generation step, an extraction step, and a visual information generation step, in which the character information generation step generates character information including a talk script of an interview from audio data of the interview, in which the extraction step extracts a keyword from the character information, and in which the visual information generation step generates visual information in which the extracted keyword is associated with a replay time point at which the keyword appears in the audio data.

Obviously, the above embodiments are not limitative of the present invention.

Lastly, although various embodiments of the present invention have been described above, these embodiments are presented merely as examples and are not intended to limit the scope of this invention. The above embodiments can be implemented in diverse variations including deletion, replacement, and change of some of their constituent elements as long as such variations fall within the scope of the present invention. It is thus to be understood that the embodiments and their variations are within the spirit and scope of the present invention and also fall within the scope of the appended claims or the equivalents thereof.

### REFERENCE SIGNS LIST

1: System
2: Audio replay terminal
3: Information processing device
30: Communication bus
31: Communication part
32: Storage part
33: Control part
331: Reception part
332: Discrimination part
333: Interview audio generation part
334: Character information generation part
335: Extraction part
336: Visual information generation part
4: First user terminal
4a: First user
5: Second user terminal
5a: Second user
6: Character information
60: Keyword
61: First character information
62: Second character information
7: Visual information
70: Icon
71: Seek bar
701: Icon
702: Icon
703: Icon

1. An information processing device configured to generate character information, extract, and generate visual information, wherein
the character information generation generates character information including a talk script of an interview from audio data of the interview,
the extraction extracts a keyword from the character information, and
the visual information generation generates visual information in which the extracted keyword is associated with a replay time point at which the keyword appears in the audio data.

2. The information processing device according to claim 1, wherein
there are a plurality of the keywords, and
the visual information generation generates the visual information in which the plurality of the keywords are to be discriminated in order of appearance thereof.

3. The information processing device according to claim 1, wherein
the visual information generation generates the visual information in which the extracted keyword is associated with a seek bar indicative of a replay position of the audio data.

4. The information processing device according to claim 3, wherein
the visual information generation generates an icon including the keyword associated with the replay time point, in a position permitting recognition of the replay time point at which the keyword appears in the seek bar.

5. The information processing device according to claim 4, wherein
the position in which the icon is recognizable is at least above, below, on the left of, or on the right of the replay time point at which the keyword appears in the seek bar.

6. The information processing device according to claim 1, wherein
the extraction extracts the keyword related to an amount of money, and
the visual information generation generates the visual information including an icon indicative of the keyword, the icon being displayed differently depending on the amount of money.

7. The information processing device according to claim 6, wherein
the visual information generation generates the icon in a case where the amount of money is equal to or larger than a predetermined amount.

8. The information processing device according to claim 6, wherein
the visual information generation generates the icon in such a manner that the icon is displayed differently either in size or in color depending on the amount of money.

9. The information processing device according to claim 1, wherein
the interview is conducted by at least two users, and
the visual information generation generates the visual information including an icon indicative of the keyword, the icon being displayed differently depending on the users.

10. The information processing device according to claim 1, wherein
the interview is conducted by a first user and a second user,
the character information generation generates first character information including the talk script of the first user and second character information including the talk script of the second user from the audio data, and
the extraction extracts the keyword from the first character information.

11. The information processing device according to claim 10, further configured to discriminate, wherein
the discrimination performs speech recognition on the audio data to discriminate a speech by the first user and a speech by the second user in the audio data,
the character information generation
generates the first character information from the speech by the first user, and
generates the second character information from the speech by the second user.

12. The information processing device according to claim 10, further configured to receive and generate interview audio, wherein
the reception receives first audio data from the first user and second audio data from the second user, and
the interview audio generation generates the audio data including discriminably the first audio data and the second audio data.

13. The information processing device according to claim 10, wherein
the first user is a sales representative and the second user is a customer, and
the audio data includes a business negotiation between the sales representative and the customer.

14. The information processing device according to claim 1, wherein
the keyword includes a unit.

15. The information processing device according to claim 1, wherein
the keyword includes a currency.

16. A computer readable medium containing a program for causing a computer to perform:
the character information generation, extraction, and visual information generation performed by the information processing device according to claim 1.

17. An information processing method for an information processing device, comprising:
character information generation;
extraction; and
visual information generation, wherein
the character information generation generates character information including a talk script of an interview from audio data of the interview,
the extraction extracts a keyword from the character information, and
the visual information generation generates visual information in which the extracted keyword is associated with a replay time point at which the keyword appears in the audio data.
